(19) United States
(12) Patent Application Publication
(10) Pub. No.: US 2022/0274122 A1
(43) Pub. Date: Sep. 1, 2022

(54) ELECTROSTATIC COATING HANDGUN

(71) Applicant: TOYOTA JIDOSHA KABUSHIKI KAISHA, Toyota-shi (JP)

(72) Inventors: Kazuki TANAKA, Toyota-shi (JP); Shinji TANI, Toyota-shi (JP)

(73) Assignee: TOYOTA JIDOSHA KABUSHIKI KAISHA, Toyota-shi (JP)

(21) Appl. No.: 17/583,743

(22) Filed: Jan. 25, 2022

(30) Foreign Application Priority Data
Feb. 26, 2021 (JP) 2021-029370

(51) Int. Cl. B05B 5/04; B05B 5/035; B05B 5/08

(52) U.S. Cl. CPC B05B 5/0407; B05B 5/035; B05B 5/08

(57) ABSTRACT

An electrostatic coating handgun configured to spray electrically charged atomized paint onto a workpiece. The electrostatic coating handgun includes: a body portion extending in a longitudinal direction, the longitudinal direction being the same direction as a spraying direction; a grip portion to be held by an operator, the grip portion extending downward from a rear part of the body portion; a rotating head configured to emit the paint, the rotating head being rotatably supported by a front end of the body portion; an air motor configured to apply rotational power to the rotating head, the air motor being located behind the rotating head in the body portion; and a high voltage generator configured to apply a voltage to the paint to be emitted from the rotating head. The air motor is located forward of the grip portion, whereas the high voltage generator is located above the grip portion.

### CROSS-REFERENCE TO RELATED APPLICATION

This application claims priority to Japanese Patent Application No. 2021-029370 filed on Feb. 26, 2021, incorporated herein by reference in its entirety.

### BACKGROUND

### 1. Technical Field

The present disclosure relates to electrostatic coating handguns for spraying electrically charged atomized paint onto an object to be coated.

### 2. Description of Related Art

In recent years, electrostatic spray coating that provides high coating quality has been automated by robots, but electrostatic spray coating that is performed by an operator using an electrostatic coating spray gun (electrostatic coating handgun) is still widely used.

Such electrostatic coating handguns for electrostatic spray coating that is performed by an operator are typically of the type that does not use a rotating head called a bell. However, there are also electrostatic coating handguns of the type that use a rotating head. For example, in a coating gun disclosed in Japanese Unexamined Patent Application Publication No. 2009-022930 (JP 2009-022930 A), a gun body is composed of a barrel portion that is long in the longitudinal direction and a grip portion extending downward from the rear end of the barrel portion, and a rotating atomizing head that discharges atomized paint forward, a turbine for rotating the rotating atomizing head, and a high voltage application device that applies static electricity to the paint are housed in the barrel portion.

### SUMMARY

The electrostatic coating handguns that are used for electrostatic spray coating by operators are often too heavy for operators to hold and work with as these electrostatic coating handguns have a mechanism designed for coating by robots.

For example, even in the coating gun of JP 2009-022930 A, all of the rotating atomizing head, the turbine, and the high voltage application device that are main functional parts are located in the front side of the barrel portion. Accordingly, the center of gravity of the coating gun is located on the front side, so that the operator holding the grip portion tends to feel the weight. The coating gun of JP 2009-022930 A therefore may not provide enough workability of electrostatic spray coating that is performed by an operator, and there is room for improvement in that respect.

The present disclosure provides a technique for improving workability of electrostatic spray coating that is performed by an operator using an electrostatic coating handgun.

In an electrostatic coating handgun according to an aspect of the present disclosure, main functional parts are placed in a body portion of the electrostatic coating handgun so that the center of gravity of the electrostatic coating handgun is located at such a point that the operator is less likely to feel the weight.

Specifically, the aspect of the present disclosure relates to an electrostatic coating handgun configured to spray electrically charged atomized paint onto an object to be coated.

This electrostatic coating handgun includes: a body portion extending in a longitudinal direction, the longitudinal direction being the same direction as a spraying direction; a grip portion to be held by an operator, the grip portion extending downward from a rear part of the body portion; a rotating atomizing head configured to emit paint, the rotating atomizing head being rotatably supported by a front end of the body portion; an air motor configured to apply rotational power to the rotating atomizing head, the air motor being located behind the rotating atomizing head in the body portion; and a high voltage generator configured to apply a voltage to the paint to be emitted from the rotating atomizing head. The air motor is located forward of the grip portion, whereas the high voltage generator is located above the grip portion.

According to this configuration, the high voltage generator is located above the grip portion, namely away from the rotating atomizing head and the air motor that need to be disposed in the front side of the electrostatic coating handgun. Accordingly, the center of gravity of the electrostatic coating handgun is located at such a point that the operator holding the grip portion is less likely to feel the weight. The structure of the electrostatic coating handgun that does not impose a burden on the operator is thus implemented. This configuration improves workability of electrostatic spray coating that is performed by the operator using the electrostatic coating handgun.

As described above, the high voltage generator is located away from the rotating atomizing head and the air motor. This configuration allows efficient voltage application to the paint, and at the same time, provides electrical insulation even if a tip end of the electrostatic coating handgun comes into contact with the operator. Safety during electrostatic spray coating is thus improved.

A paint hose extending from a paint supply device etc., an air hose extending from an air supply device etc., a power cable for supplying electricity to a high voltage generator, etc. are typically connected to an electrostatic coating handgun. When the paint hose, the air hose, and the power cable are directly connected to near a rotating atomizing head, an air motor, and a high voltage generator, respectively, the plurality of hoses etc. are connected to the electrostatic coating handgun in a disorderly manner. This may reduce workability of electrostatic spray coating that is performed by an operator.

Accordingly, in the above electrostatic coating handgun, a paint flow path through which the paint is supplied to the rotating atomizing head, an air flow path through which air is supplied to the air motor, and an electrical flow path through which electricity is supplied to the high voltage generator may be placed so as to pass through a portion located below a part of the grip portion to be held by the operator.

According to this configuration, these flow paths can be placed together in the portion located below the part of the grip portion that is held by the operator. A plurality of hoses, electrical wires, etc. are therefore connected to the portion located below the grip portion in a simple and orderly manner so that the hoses, electrical wires, etc. will not get in the way when the operator holds the grip portion. This configuration improves workability of electrostatic spray coating.

In the electrostatic coating handgun, the high voltage generator may be located above a longitudinal axis of the rotating atomizing head and the air motor.

According to this configuration, the high voltage generator is located at a different height from the rotating atomizing head and the air motor. This configuration thus provides a greater insulation distance and further improves safety during electrostatic spray coating.

The electrostatic coating handgun may be configured to electrostatically atomize the paint without using shaping air.

As described above, in the electrostatic coating handgun of the present disclosure, electrical insulation is provided by separating the high voltage generator from the rotating atomizing head and the air motor. Accordingly, the present disclosure can be particularly suitably used for electrostatic atomization handguns that electrostatically atomize paint using a high voltage.

As described above, the electrostatic coating handgun according to the present disclosure provides improved workability of electrostatic spray coating that is performed by an operator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an electrostatic coating device including an electrostatic coating handgun according to an embodiment of the present disclosure;

FIG. 2 schematically illustrates an electrostatic field formed between a rotating head and an object to be coated;

FIG. 3 schematically shows the electrostatic coating handgun;

FIG. 4 is a schematic sectional view of the rotating head; and

FIG. 5 is a schematic perspective view of a tip end of the rotating head.

### DETAILED DESCRIPTION OF EMBODIMENTS

A mode for carrying out the disclosure will be described below with reference to the drawings.

### Electrostatic Coating Device

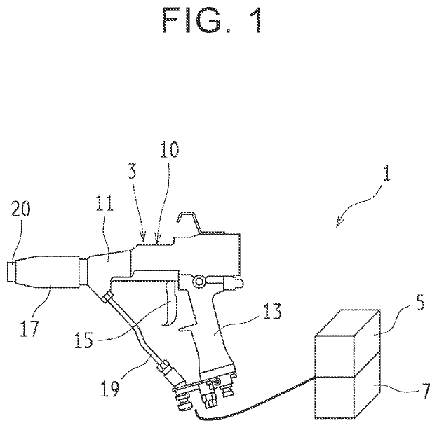

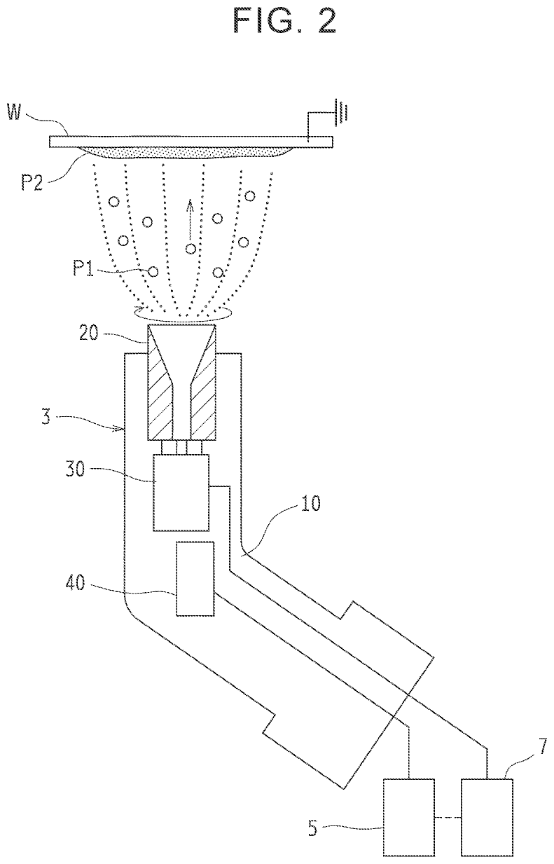

FIG. 1 schematically shows an electrostatic coating device 1 including an electrostatic coating handgun 3 according to an embodiment. The electrostatic coating device 1 is an electrostatic atomization type coating device that electrostatically atomizes paint P1 (see FIG. 2). As shown in FIG. 1, the electrostatic coating device 1 includes the electrostatic coating handgun 3, a high voltage controller 5, an air motor controller 7, an air supply device (not shown), and a paint supply device (not shown).

The electrostatic coating handgun 3 is a device that sprays electrically charged atomized paint P1 onto a workpiece (object to be coated) W (see FIG. 2) by a manual operation by an operator holding the electrostatic coating handgun 3. The electrostatic coating handgun 3 is connected to the high voltage controller 5 and the air motor controller 7. The air supply device supplies high pressure air to the electrostatic coating handgun 3. The high pressure air serves as a rotational driving source for a rotating head (rotating atomizing head) 20 of the electrostatic coating handgun 3. The paint supply device supplies the water-based paint P1 for electrostatic atomization coating to the electrostatic coating handgun 3. The paint P1 is, for example, paint made of a resin containing water.

FIG. 2 schematically illustrates an electrostatic field formed between the rotating head 20 and the workpiece W. FIG. 2 merely illustrates the electrostatic field and does not accurately show the shape of the electrostatic coating handgun 3 and the arrangement of the main functional parts in the electrostatic coating handgun 3. As will be described later, the paint P1 discharged in the form of filaments from the rotating head 20 is electrostatically atomized as it breaks up into droplets by the electrostatic force of the electrostatic field formed between the rotating head 20 and the workpiece W. As shown in FIG. 2, the paint P1 thus electrostatically atomized is attracted and adheres to the grounded workpiece W due to the negative charge of the paint P1. As a result, a coating film P2 is formed on the surface of the workpiece W.

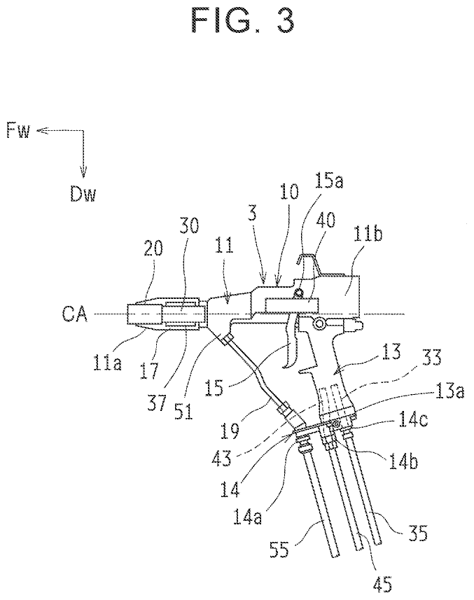

The high voltage controller 5 controls the output voltage of a high voltage generator 40 (see FIG. 3) of the electrostatic coating handgun 3 to adjust the strength of the electrostatic field in order to control the particle size of the paint P1 to be electrostatically atomized to the particle size suitable for coating or to reduce variation in particle size of the paint P1 to be electrostatically atomized.

The coating pattern can also be controlled by adjusting the strength of the electrostatic field by the high voltage controller 5. For example, when the strength of the electrostatic field is increased by the high voltage controller 5, the electrostatically atomized paint P1 is driven more straight, so that the resultant coating pattern becomes narrower. On the other hand, when the strength of the electrostatic field is decreased by the high voltage controller 5, the electrostatically atomized paint P1 is driven less straight, so that the resulting coating pattern becomes wider.

In the present embodiment, the high voltage controller 5 controls the output voltage of the high voltage generator 40 so that the current (discharge current) discharged from the open end of the rotating head 20 is always constant. Since the potential difference V is changed according to a change in distance between the workpiece W and the rotating head 20, fluctuations in electric field strength E are reduced. Specifically, as the distance between the workpiece W and the rotating head 20 increases, a resistance component R (spatial resistance value) for the discharge current I increases. The high voltage controller 5 therefore controls the high voltage generator 40 so that the output voltage of the high voltage generator 40 increases (the potential difference V (=R I) increases) as the distance between the workpiece W and the rotating head 20 increases. On the other hand, as the distance between the workpiece W and the rotating head 20 decreases, the resistance component R (spatial resistance value) for the discharge current I decreases. The high voltage controller 5 therefore controls the high voltage generator 40 so that the output voltage of the high voltage generator 40 decreases (the potential difference V (=R×I) decreases) as the distance between the workpiece W and the rotating head 20 decreases. Fluctuations in electric field strength E are thus reduced, and as a result, variation in particle size of the paint P1 to be electrostatically atomized is reduced. Accordingly, the electrostatic atomization of the paint P1 can be stabilized, and the coating efficiency can also be stabilized.

The air motor controller 7 is connected to the electrostatic coating handgun 3 and controls the rotational speed of an air motor 30. The air motor controller 7 is electrically connected to the high voltage controller 5, and sends and receives information to and from the high voltage controller 5.

### Electrostatic Coating Handgun

FIG. 3 schematically shows the electrostatic coating handgun 3. In FIG. 3, only a body portion 11 of a housing 10 is shown in cross section. An arrow Fw in FIG. 3 indicates the front side in the longitudinal direction, and an arrow Dw in FIG. 3 indicates the lower side in the vertical direction. As shown in FIG. 3, the electrostatic coating handgun 3 includes the rotating head 20, the air motor 30, the high voltage generator 40, and the housing 10. The housing 10 supports or houses the rotating head 20, the air motor 30, and the high voltage generator 40.

As shown in FIG. 3, the housing 10 includes: the body portion 11 having a cap 17; a grip portion 13 that is held by the operator; and a trigger 15 that is pulled by a finger of the operator holding the grip portion 13. The body portion 11 extends in the longitudinal direction that is the same direction as the spraying direction, while the grip portion 13 extends downward from a rear part 11b of the body portion 11.

The body portion 11 is made of an electrically insulating material such as electrically insulating resin. The rotating head 20 is rotatably supported by a front end 11a of the body portion 11 with a tip end of the rotating head 20 exposed. The air motor 30 is housed behind the rotating head 20 inside the body portion 11. The high voltage generator 40 is housed above the grip portion 13 inside the body portion 11. As shown in FIG. 3, the high voltage generator 40 is located above a longitudinal axis CA of the rotating head 20 and the air motor 30 inside the body portion 11. The cap 17 is attached to a tip end of the body portion 11. The cap 17 covers the outer peripheral surface of the rotating head 20 except the tip end of the rotating head 20 and also covers a part of the air motor 30.

The grip portion 13 is made of an electrically conductive material such as electrically conductive resin and is grounded by a ground wire (not shown), so that electric charge will not accumulate on the operator's body even when the operator holds the grip portion 13. As shown by dashed lines in FIG. 3, there is an air supply passage 33 inside the grip portion 13, and an electrical cable 43 electrically connected to the high voltage generator 40 is placed inside the grip portion 13. A connection port portion 14 is located at a lower end 13a of the grip portion 13 (a portion located below a part of the grip portion 13 that is held by the operator). The connection port portion 14 is provided with a paint supply port 14a, a power supply port 14b, and an air supply port 14c in this order from the front side of the connection port portion 14.

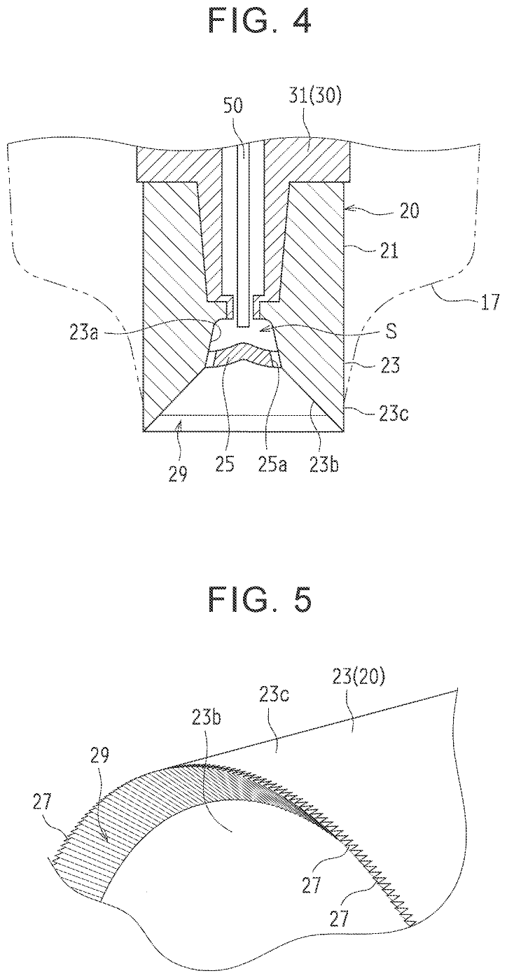

A paint hose 55 for supplying the paint P1 from the paint supply device to the electrostatic coating handgun 3 is connected to the paint supply port 14a. The body portion 11 has a paint inlet port 51 behind the air motor 30, and the paint supply port 14a is connected to the paint inlet port 51 through a paint supply hose 19. The paint inlet port 51 communicates with a paint supply pipe 50 inserted through a rotating shaft 31 (see FIG. 4) of the air motor 30. The paint P1 fed from the paint supply device is thus supplied to the paint supply pipe 50 through the paint hose 55 and the paint supply hose 19. The paint hose 55 and the paint supply hose 19 of the present embodiment can be regarded as the “paint flow path that supplies the paint to the rotating atomizing head” of the present disclosure.

A power cable 45 for supplying electricity from a power supply (not shown) to the electrostatic coating handgun 3 is connected to the power supply port 14b. The power supply port 14b is connected to the high voltage generator 40 via the electrical cable 43. Electricity is thus supplied to the high voltage generator 40 via the power cable 45 and the electrical cable 43. The power cable 45 and the electrical cable 43 of the present embodiment can be regarded as the “electrical flow path that supplies electricity to the high voltage generator” of the present disclosure.

An air hose 35 for supplying high pressure air from the air supply device to the electrostatic coating handgun 3 is connected to the air supply port 14c. The air supply port 14c is connected to the air motor 30 through the air supply passage 33. High pressure air is thus supplied to the air motor 30 through the air hose 35 and the air supply passage 33. The air hose 35 and the air supply passage 33 of the present embodiment can be regarded as the “air flow path that supplies air to the air motor” of the present disclosure.

The trigger 15 is attached to the body portion 11 so as to be rotatable back and forth about a rotating shaft 15a. When the operator holding the grip portion 13 pulls the trigger 15, the trigger 15 opens a trigger valve (not shown) to supply the paint P1 fed from the paint supply device to the body portion 11 through the paint hose 55 and the paint supply hose 19 to the rotating head 20 through the paint supply pipe 50.

FIG. 4 is a schematic sectional view of the rotating head 20. The rotating head 20 has, in its tip end (grooved portion 29), grooves 27 (see FIG. 5) for emitting the paint P1. The rotating head 20 discharges (emits) the supplied liquid paint P1 by centrifugal force generated by rotation of the rotating head 20. As shown in FIG. 4, the rotating head 20 has a generally cylindrical shape, and includes an attachment portion 21 in the base end side (rear side) of the rotating head 20 and a head portion 23 in the tip end side (front side) of the rotating head 20. The diameter of the rotating head 20 is, for example, 20 to 50 mm. The attachment portion 21 is fitted on the rotating shaft 31 of the air motor 30. The rotating shaft 31 of the air motor 30 is hollow, and as described above, the paint supply pipe 50 for supplying the paint P1 to the head portion 23 is located inside the rotating shaft 31.

The head portion 23 has a first inner peripheral surface 23a, a second inner peripheral surface 23b, and an outer peripheral surface 23c. The first inner peripheral surface 23 a is shaped like a tapered surface of a truncated cone, and the diameter of the first inner peripheral surface 23a increases as it gets closer to a tip end of the head portion 23. The second inner peripheral surface 23b extends from a tip end of the first inner peripheral surface 23a and is also shaped like a tapered surface of a truncated cone. The diameter of the second inner peripheral surface 23b increases at a higher rate than the diameter of the first inner peripheral surface 23a as it gets closer to the tip end of the head portion 23. The outer peripheral surface 23c has a generally cylindrical surface. A hub 25 is provided radially inside the first inner peripheral surface 23a, and a paint space S is defined by the first inner peripheral surface 23a and the hub 25. A tip end of the paint supply pipe 50 faces the paint space S. The hub 25 has, in its outer edge portion, an outlet hole 25a through which the paint P1 flows out of the paint space S. The second inner peripheral surface 23b functions as a diffusion surface by which the paint P1 having flowed out of the paint space S through the outlet hole 25a is diffused by centrifugal force. The second inner peripheral surface 23b has the grooved portion 29 in its tip end. The grooved portion 29 has the grooves 27.

FIG. 5 is a schematic perspective view of the tip end of the rotating head 20. The grooves 27 are provided in order to discharge the paint P1 in the form of filaments. Specifically, the grooves 27 extend in the axial direction to the tip end (front end) of the rotating head 20 and are tilted radially outward along the second inner peripheral surface 23b. The grooves 27 (e.g., 600 to 1200 grooves) are provided in the circumferential direction. Each groove 27 has a V-shaped (triangular) cross section. The cross section of each groove 27 appears on the outer peripheral surface 23c. The tip end of the rotating head 20 therefore has a jagged edge as viewed from the outer peripheral surface 23c side.

The air motor 30 is located behind the rotating head 20 and forward of the grip portion 13 in the body portion 11 of the housing 10. The rotating shaft 31 of the air motor 30 is connected to the rotating head 20, and the air motor 30 applies rotational power to the rotating head 20 using high pressure air supplied from the air supply device through the air hose 35 and the air supply passage 33. The air motor 30 is relatively small in order to reduce the burden on the operator. The air motor controller 7 controls the rotational speed of the air motor 30. A brake mechanism 37 is located around the air motor 30. The brake mechanism 37 stops the rotation of the air motor 30 by holding the rotating shaft 31.

The high voltage generator 40 is a device that applies a voltage to the paint P1. The high voltage generator 40 negatively charges the rotating head 20 by generating a negative high voltage and applying it to the rotating head 20. A strong electrostatic field is thus formed between the rotating head 20 serving as a negative electrode and the grounded workpiece W serving as a positive electrode.

As described above, the electrostatic coating handgun 3 of the present embodiment electrostatically atomizes the paint P1 by the electrostatic force in the electrostatic field formed between the rotating head 20 and the workpiece W without using shaping air. Accordingly, the coating efficiency is improved as the paint particles adhering to the workpiece W and the paint particles floating near the workpiece W are not lifted by the airflow accompanying the shaping air. Moreover, generating ionic wind from the tip end of the rotating head 20 by glow discharge can assist stable flight and pattern formation of the atomized paint P1.

### Electrostatic Spray Coating

When coating the workpiece W using the electrostatic coating device 1 configured as described above, the electrostatic coating device 1 is first started to rotate the rotating head 20 at high speed and to apply a negative high voltage to the rotating head 20. An electrostatic field is thus formed between the rotating head 20 and the workpiece W. Next, the operator pulls the trigger 15. The trigger valve thus opens, so that the paint P1 fed from the paint supply device to the body portion 11 through the paint supply hose 19 is supplied to the rotating head 20 through the paint supply pipe 50.

The paint P1 supplied to the rotating head 20 is subjected to the centrifugal force and is discharged in the form of filaments in the direction of the centrifugal force from the grooved portion 29 (grooves 27) formed on the tip end of the second inner peripheral surface 23b of the rotating head 20. The paint P1 discharged in the form of filaments is electrostatically atomized as it breaks up into droplets by the electrostatic force of the electrostatic field formed between the rotating head 20 and the workpiece W. The electrostatically atomized paint P1 is attracted and adheres to the grounded workpiece W due to the negative charge of the paint P1. The coating film P2 is thus formed on the surface of the workpiece W.

### Improvement in Safety by Control

In the electrostatic coating handgun 3 of the type that does not use shaping air as in the present embodiment, it is difficult to provide a protective cover outside the rotating head 20. Since there is no air moving from the rear side toward the front side, coating would not be properly performed as the paint P1 discharged from the tip end of the rotating head 20 would scatter in a direction tangential to the rotation of the rotating head 20 and would adhere to the protective cover.

However, since the tip end of the rotating head 20 is machined to be sharp in order to atomize the paint P1 as shown in FIG. 5, some safety measures are required as the operator may get a cut etc. if he or she touches the rotating head 20 rotating at high speed.

Therefore, in the electrostatic coating handgun 3 of the present embodiment, the air motor controller 7 reduces the rotational speed of the air motor 30 when the current value discharged from the rotating head 20 increases. Moreover, the high voltage controller 5 controls the output voltage of the high voltage generator 40 to zero and the air motor controller 7 stops the rotation of the air motor 30 when the amount of change (amount of increase) per unit time in current value discharged from the rotating head 20 is larger than a predetermined amount of change (predetermined amount of increase) or when the absolute value of the current value discharged from the rotating head 20 is larger than a predetermined value. Moreover, the air motor controller 7 uses the brake mechanism 37 when stopping the rotation of the air motor 30.

As described above, when the voltage of the high voltage generator 40 is approximately constant, the current value discharged from the rotating head 20 varies according to the spatial resistance value between the workpiece W located in front of the rotating head 20, the operator, etc. and the rotating head 20. This spatial resistance value becomes smaller as the distance between the workpiece W, the operator, etc. and the rotating head 20 decreases.

In the present embodiment, the current value discharged from the rotating head 20 increases as the rotating head 20 approaches the workpiece W or the operator. Accordingly, the high voltage controller 5 sends a command to reduce the output voltage of the high voltage generator 40 in order to keep this current value constant. At this time, information indicating that the current value has increased is transmitted from the high voltage controller 5 to the air motor controller 7, and in response to this information, the air motor controller 7 sends a command to reduce the rotational speed of the air motor 30. This reduces the possibility that the rotating head 20 rotating at high speed may contact the workpiece W, the operator, etc. Safety during electrostatic coating is thus ensured even in the electrostatic coating handgun 3 of the type that does not use shaping air, namely in the electrostatic coating handgun 3 in which it is difficult to provide a protective cover outside the rotating head 20.

Moreover, in a more urgent situation than a situation where the rotating head 20 normally approaches the workpiece W, the operator, etc., specifically, when the amount of change per unit time in current value is larger than the predetermined amount of change (when the rotating head 20 has rapidly approached the workpiece W, the operator, etc.) or when the absolute value of the current value is larger than the predetermined value (when the distance between the workpiece W, the operator, etc. and the rotating head 20 is extremely short), the high voltage controller 5 sends a command to control the output voltage of the high voltage generator 40 to zero and the air motor controller 7 sends a command to stop the rotation of the air motor 30. This can prevent the operator from getting an electric shock, a cut, etc.

Even when it is difficult to deal with a sudden decrease in rotational speed of the air motor 30 by merely sending an output stop command to the air motor 30, the air motor controller 7 sends a command to operate the brake mechanism 37 to hold the rotating shaft 31 after supply of high pressure air to the air motor 30 is stopped. The air motor 30 can thus be stopped more quickly and more reliably. Safety is therefore more reliably ensured.

### Improvement in Workability by Structure

The electrostatic coating handgun 3 of the present embodiment has improved workability as it has the above configuration. Specifically, the high voltage generator 40 is located above the grip portion 13 in the body portion 11, namely away from the rotating head 20 and the air motor 30 that need to be disposed in the front side of the electrostatic coating handgun 3. With this configuration, the center of gravity of the electrostatic coating handgun 3 is located at such a point that the operator holding the grip portion 13 is less likely to feel the weight. The structure of the electrostatic coating handgun 3 that does not impose a burden on the operator is thus implemented. This configuration improves workability of electrostatic spray coating that is performed by the operator using the electrostatic coating handgun 3.

As described above, the high voltage generator 40 is located away from the rotating head 20 and the air motor 30. This configuration allows efficient voltage application to the paint P1, and at the same time, provides electrical insulation even if a tip end of the electrostatic coating handgun 3 comes into contact with the operator. Safety during electrostatic spray coating is thus improved.

Moreover, the high voltage generator 40 is located at a different height from the rotating head 20 and the air motor 30. This configuration provides a greater insulation distance and further improves safety during electrostatic spray coating.

In the electrostatic coating handgun 3 of the present embodiment, the paint flow path composed of the paint hose 55 and the paint supply hose 19, the air flow path composed of the air hose 35 and the air supply passage 33, and the electrical flow path composed of the power cable 45 and the electrical cable 43 are placed so as to pass through the connection port portion 14 located at the lower end 13a of the grip portion 13. These flow paths can thus be placed together in the portion located below the part of the grip portion 13 that is held by the operator. The hoses 35, 55 and the cable 45 are therefore connected to the connection port portion 14 in a simple and orderly manner so that the hoses 35, 55 and the cable 45 will not get in the way when the operator holds the grip portion 13. This configuration improves workability of electrostatic spray coating.

### Other Embodiments

The present disclosure is not limited to the embodiment and can be embodied in various other forms without departing from the concept or main features of the present disclosure.

In the above embodiment, the paint P1 is a water-based paint. However, the present disclosure is not limited to this, and the paint P1 may be an oil-based paint (solvent-based paint).

In the above embodiment, the present disclosure is applied to the electrostatic coating handgun 3 of the type that does not use shaping air. However, the present disclosure is not limited to this, and the present disclosure may be applied to, for example, an electrostatic coating handgun of the type that uses shaping air.

In the above embodiment, the present disclosure is applied to the electrostatic atomization type electrostatic coating device 1. However, the present disclosure is not limited to this, and the present disclosure may be applied to an electrostatic coating device of the type (air atomization type or airless atomization type) that atomizes paint by injecting the paint from a handgun with a mechanical force (e.g., compressed air or high pressure applied to the paint) and electrically charges the atomized paint.

In the above embodiment, the air supply passage 33 is located inside the grip portion 13. However, the present disclosure is not limited to this, and the air supply passage 33 may be composed of, for example, a hose that extends parallel to the paint supply hose 19 from the connection port portion 14 to the body portion 11.

As described above, the above embodiment is merely by way of example in all respects and should not be construed as restrictive. All modifications and changes that fall within the scope equivalent to the claims fall within the scope of the present disclosure.

Since the present disclosure improves workability of electrostatic spray coating that is performed by an operator, the present disclosure is extremely useful when applied to electrostatic coating handguns.

What is claimed is:

1. An electrostatic coating handgun configured to spray electrically charged atomized paint onto an object to be coated, the electrostatic coating handgun comprising:
a body portion extending in a longitudinal direction, the longitudinal direction being the same direction as a spraying direction;
a grip portion to be held by an operator, the grip portion extending downward from a rear part of the body portion;
a rotating atomizing head configured to emit the paint, the rotating atomizing head being rotatably supported by a front end of the body portion;
an air motor configured to apply rotational power to the rotating atomizing head, the air motor being located behind the rotating atomizing head in the body portion; and
a high voltage generator configured to apply a voltage to the paint to be emitted from the rotating atomizing head, wherein the air motor is located forward of the grip portion, whereas the high voltage generator is located above the grip portion.

2. The electrostatic coating handgun according to claim 1, wherein a paint flow path through which the paint is supplied to the rotating atomizing head, an air flow path through which air to the air motor is supplied, and an electrical flow path through which electricity is supplied to the high voltage generator are placed so as to pass through a portion located below a part of the grip portion to be held by the operator.

3. The electrostatic coating handgun according to claim 1, wherein the high voltage generator is located above a longitudinal axis of the rotating atomizing head and the air motor.

4. The electrostatic coating handgun according to claim 1, wherein the electrostatic coating handgun is configured to electrostatically atomize the paint without using shaping air.
